(19) United States
(12) Patent Application Publication
(10) Pub. No.: US 2026/0172824 A1
(43) Pub. Date: Jun. 18, 2026

(54) DEVICES, SYSTEMS, AND METHODS FOR AUTHENTICATING SERVICE PROVIDER COMMUNICATIONS

(71) Applicant: The PNC Financial Services Group, Inc., Pittsburgh, PA (US)

(72) Inventors: Robert Schukai, Pittsburgh, PA (US); Richard Graham, Pittsburgh, PA (US)

(73) Assignee: The PNC Financial Services Group, Inc., Pittsburgh, PA (US)

(21) Appl. No.: 18/983,156

(22) Filed: Dec. 16, 2024

(51) Int. Cl. H04W 12/06

(52) U.S. Cl. CPC H04W 12/06

(57) ABSTRACT

A method of authenticating service provider communications is disclosed herein. The method can include receiving, via a mobile communication device, a communication via an unverified communication channel, establishing, via the mobile communication device, a second, secure communication channel between the mobile communication device and a service provider server, receiving, via the mobile communication device, a first user input comprising authentication information in response to the communication, generating, via the mobile communication device, a unique authentication request comprising the authentication information, transmitting, via the mobile communication device, the unique authentication request to the service provider server via the second, secure communication channel, receiving, via the mobile communication device, an authentication response from the originator of the communication, and determining whether the originator of the communication is a service provider associated with a user of the mobile communication device based on the authentication response.

### BACKGROUND

Existing authentication protocols are commonly used by service providers (e.g., financial institutions, doctors, government representatives, etc.) to ensure that customer data and assets are only accessed by the providing customer or other authorized users. For example, financial institutions may employ such protocols, requiring customers to provide large quantities of information (e.g., identification information, personal identification numbers (PIN), knowledge based questions, answers to knowledge based questions, one-time codes, etc.) to verify the customer's identity prior to allowing the customer to open and/or access an account.

However, no such mechanisms exists for customers to authenticate alleged representatives of service providers prior to initiating a communication. Communications (e.g., calls, emails, text messages, etc.) may include specific details that create the illusion of legitimacy, at least on their face. For example, an email may include the service provider's branding, a relevant domain name, a customer's name, a recent transaction, a partial account number, or other information that can be easily spoofed or illegitimately accessed to wrongly establish a sense of trust in the customer. Trademarks can be copied and pasted from the Internet, caller identification can be manipulated, and hyperlinks configured a customer data may accompany seemingly legitimate communications from service providers. Thus, even though a communication may appear authentic, it is difficult to reliably distinguishing legitimate communications from scams or phishing attempts. Customers, therefore, are constantly at risk of inadvertently divulging sensitive information to malicious actors as they try to go about their everyday business. Accordingly, there is a need for devices, systems, and methods for authenticating service provider communications.

### SUMMARY

Assume that a customer of a service provider receives a communication (e.g., phone call, email, text, etc.) from an originator of the communication purporting to be the service provider and seeking to have a sensitive conversation with the customer. Because phone numbers, names, email addresses, area codes, and domain names can be spoofed, the communication is unverified and the customer has no available means of authenticating that the originator of the communication is who they purport to be—the service provider. In one general aspect, the present disclosure is directed to a method of authenticating service provider communications. The method can be implemented by a system that includes a mobile communication device, a service provider server, and/or a service provider device, or components thereof.

For example, the method can include receiving, via a mobile communication device, the initial communication via an unverified communication channel. In response to the communication, the method can include establishing, via the mobile communication device, a secure communication channel between the mobile communication device and a service provider server, such as via an trusted service provider application utilized by the customer throughout the ordinary course of dealing with the service provider. The method can further include generating and transmitting, via the mobile communication device, a unique authentication request comprising authentication information provided by the customer via a user interface of the service provider application. The unique authentication request can be accessed by a service provider device and/or a user of the service provider device and used to generate an authentication response that includes responsive authentication information. Based on the authentication response, the user of the customer mobile device can determine whether the originator of the communication is actually the purported service provider. According to various aspects, varying risk mitigation actions and degrees of automation can be implemented by the system or components thereof, thereby enhancing the security of communications between customers and service providers.

### FIGURES

Various embodiments of the present invention are described herein by way of example in conjunction with the following figures.

FIG. 1 is a block diagram of a system for authenticating service provider communications according to one non-limiting aspect of the present disclosure.

FIG. 2 is a flow diagram of a method performed by the system of FIG. 1 according to one non-limiting aspect of the present disclosure.

FIG. 3 is a flow diagram of another method performed by the system of FIG. 1 according to one non-limiting aspect of the present disclosure.

FIGS. 4, 5 and 6 are user interfaces to be displayed via the mobile communication device of the system of FIG. 1 according to various non-limiting aspects of the present disclosure.

FIG. 7 is a block diagram of a mobile communication device according to various non-limiting aspects of the present disclosure.

### DESCRIPTION

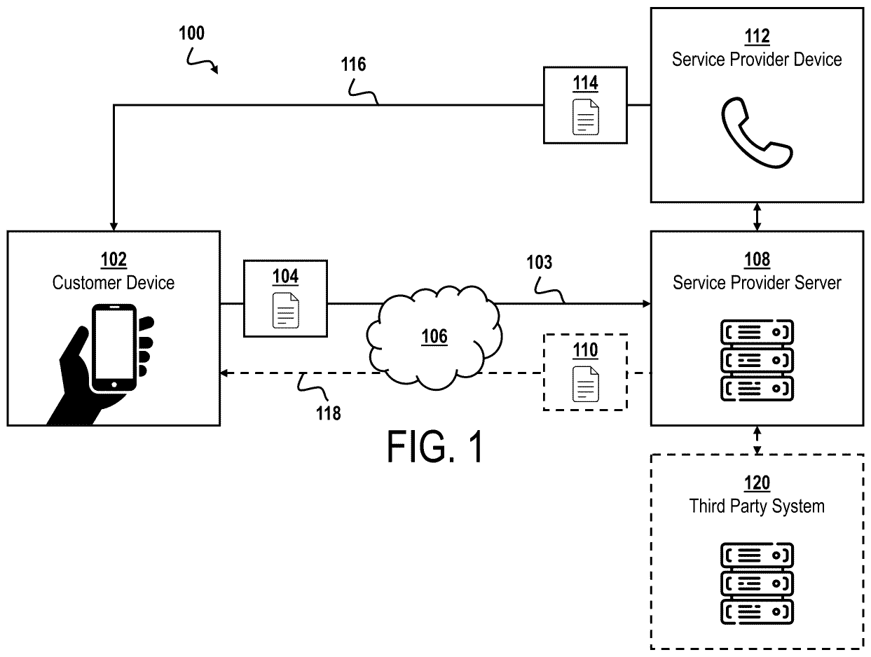

FIG. 1 depicts a system 100 for authenticating service provider communications. According to the non-limiting aspect of FIG. 1, the system 100 can include a customer device 102 in communication with a service provider server 108 via a communications network 106, such as the Internet. The customer device 102 and service provider server 108 can access the communications network 106 via any conventional means, including a wired connection (e.g., a local area network), a wireless network (e.g., WiFi®), a cellular network, and/or a satellite connection, amongst others. The customer device 102, for example, can include any computing device associated with a customer of the service provider. Although the present disclosure describes a non-limiting aspect wherein the customer is an account holder and the service provider is a financial institution, it shall be appreciated that such aspects are merely exemplary. According to other non-limiting aspects, the customer can be customer of any business. For example, according to other non-limiting aspects, the service provider can be a healthcare provider, a government agency, a utility provider, or an insurance agent, amongst others. In other words, the devices, systems, and methods disclosed herein can be implemented on behalf of any service provider that cultivates and depends on customer trust. It shall be appreciated that malicious actors can exploit such trust to illegally obtain sensitive information from customers.

In further reference to FIG. 1, the customer device 102 can include a mobile communication device, such as a smartphone, a wearable device, or a laptop, amongst other mobile communication devices. However, according to some aspects, the customer device 102 can include less mobile devices, such as a personal computer, a server, or any other device that includes a processor and a memory. According to some non-limiting aspects, the memory can be configured to store an application that, when executed by the processor, causes the customer device 102 to perform the functionality disclosed herein. However, according to other non-limiting aspects, the customer device 102 can otherwise access the application, such as via a website hosted by the service provider server 108. The customer device 102 can additionally either include an integral display or can otherwise be configured for communicative coupling with a peripheral display. Therefore, when accessed by the computing device 102, the application can present a user interface via the display. The application can be configured for use throughout the ordinary course of dealing between the customer and the service provider. For example, according to the non-limiting aspect of FIG. 1, the application can be configured to enable the customer to view an account balance, make a transaction, and/or apply for a loan, amongst other services provided by the service provider. According to other non-limiting aspects, the application may include a patient portal, customer portal, or any other means by which the customer can securely interact with the service provider. Additionally, customer access to the application can be restricted and only granted via the approval of user authenticating credentials. Thus, when accessed by the customer device 102, the application can represent a secure, trusted communication channel 103 by which the customer device 102 can communicate with the service provider server 108.

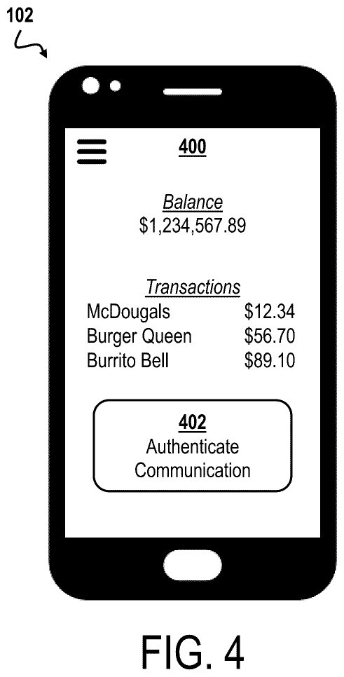

The system 100 of FIG. 1 can be implemented when the customer device 102 receives a communication from an entity purporting to represent the service provider. For example, upon receipt of the communication, a user of the customer device 102 can provide the customer device 102 with a user input that includes authentication information, as will be discussed in further detail with reference to the non-limiting example of FIG. 4. Upon receipt, the customer device 102 can generate a unique authentication request 104 that includes the authentication information and transmit the unique authentication request 104 to the service provider server 108 and/or service provider device 112 via the communications network 106. As will be described in further detail herein, the service provider server 108 and/or the service provider device 112 can be configured to use the unique authentication request 104—and more specifically, authentication information within the unique authentication request 104—to authenticate the communication received by the customer device 102 as having originated from the service provider device 112.

According to the non-limiting aspect of FIG. 1, the service provider server 108 and/or the service provider device 112 can receive the unique authentication request 104 from the customer device 102 via the communications network 106. For example, according to some non-limiting aspects, the service provider server 108 can receive and temporarily store the unique authentication request 104. The service provider device 112 can be communicatively coupled to the service provider server 108 and thus, the service provider device 108 can access the unique authentication request 104 and its associated authentication information. According to other non-limiting aspects, a user of the service provider device 112 can manually access the service provider server 108. The service provider device 112 or a user of the service provider device 112 must have prior authorization to access service provider server 108. For example, both the service provider device 112 and the service provider server 108 can be communicatively coupled by an intranet or any other private network with restricted access. Service provider access may be restricted and only granted via the approval of service provider authenticating credentials. As such, the service provider device 112 and the service provider server 108 can be specifically configured to preclude a malicious actor from accessing the service provider device 112 and the service provider server 108 via a malicious actor device (not shown).

Although the non-limiting aspect of FIG. 1 depicts both a service provider server 108 and a service provider device 112, according to other non-limiting aspects, the unique authentication request 104 can be transmitted directly to the service provider device 112 and therefore, the service provider server 108 can be omitted from the system 100. Alternately, the service provider server 108 can be configured to directly initiate communications with the customer device 102 and, therefore, the service provider device 112 can be omitted from the system 100. Thus, it shall be appreciated that the system 100 of FIG. 1 can be modified while still performing the functionality disclosed herein.

The service provider device 112, as depicted in the non-limiting aspect of FIG. 1, can include a telephone, a cellular phone, or a smartphone, a tablet, a wearable device, a personal computer, a laptop, a server, or any other device configured to communicate with the customer device 102 over an unverified communication channel 116. The unverified communication channel 116 may be established at the request of the service provider and therefore, unlike the secure communication channel 103, the unverified communication channel 116 may be unsecure or untrusted, at least from the perspective of the customer device 102. Accordingly, there is a need for the customer device 102 to authenticate the unverified communication channel 116 as actually originating from the service provider. According to some non-limiting aspects, communications between the service provider device 112 and the customer device 102 can be voice-based and, therefore, the unverified communication channel 116 can include a wired landline, a cellular connection, a voice-over-Internet protocol (VOIP), and/or any other communication channels configured to communicatively couple the service provider device 112 to the customer device 102. However, according to other non-limiting aspects, communications between the service provider device 112 and the customer device 102 can include other media, including texts, pictures, and/or videos. The communication channel may include a short messaging service (SMS) protocol. Alternately, the unverified communication channel 116 may be established via the Internet and/or may include a “chat” widget configured to facilitate instant messaging, and/or an electronic mail platform, amongst other means of communicating with the customer device 102. It shall be appreciated that the unverified communication channel 116 can be specifically configured to facilitate the desired type of communications between the service provider device 112 and the customer device 102.

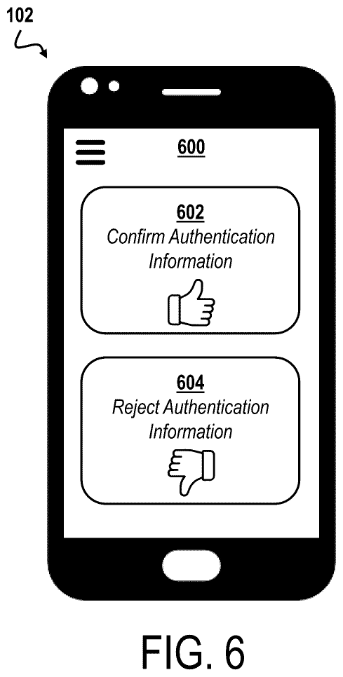

Upon receipt of an unauthenticated communication via the unverified communication channel 116, the user of the customer device 102 can access the application and provide authentication information, which the customer device 102 uses to generate a unique authentication request 104 that is transmitted to the service provider server 108 and/or service provider device 112 via the secure communication channel 103. The user of the customer device 102 can subsequently request the originator of the unauthenticated communication to provide an authentication response 114, which can include responsive authentication information that can be used to authenticate the originator as the service provider or an authorized agent of the service provider. The authentication response 114 can be audibly or digitally transmitted. For example, the customer device 102 can output the authentication response 114 audibly, via a speaker of the customer device 102, or visually, via a display of the customer device 102. Assuming the originator of the unauthenticated communication is the service provider, or an authorized agent of the service provider, the originator will have access to the service provider device 112 and/or the service provider server 108. Accordingly, the originator will have access to the authentication information provided by the customer device 102 via the unique authentication request 104. The user of the customer device 102 can assess whether the authentication response 114 includes responsive authentication information that corresponds to the authentication information from the unique authentication request 104. The assessment can either be performed audibly or digitally, for example, via the user interface 600 of FIG. 6. If the authentication response 114 includes the authentication information from the unique authentication request 104, the user of the customer device 102 can authenticate the communication as originating from the service provider or an authorized agent of the service provider, and can preserve the unverified communication channel 116. However, if the authentication response 114 does not include the authentication information from the unique authentication request 104, the communication is not authenticated and either the user of the customer device 102 or the customer device 102 itself may implement a risk mitigation action, such as terminating the unverified communication channel 116, thereby terminating the communication, recording the communication itself, recording information associated with the communication (e.g., a name of originator, a date, a time, a location, a phone number, an IP address, etc.), reporting the communication to the service provider or a third party (e.g., the police, an IT management firm, a telecommunications provider, etc.), and/or blocking information associated with the communication (e.g., a phone number, an IP address, etc.), thereby preventing the originator from initiating future communications with the customer device 102, amongst other risk mitigation actions. The reporting can be performed via the customer device 102 by transmitting the information associated with the communication to the third party system via a communication circuit of the mobile computing device. The mobile communication device can block the unverified originator from initiating another communication by storing the information associated with the communication on a black list stored in the memory of the mobile communication device. The mobile communication device can be configured to autonomously reject communications comprising information on the black list.

Such risk mitigation actions can be manually implemented by the user of the customer device 102 or autonomously implemented via the application accessed by the customer device 102. For example, according to some non-limiting aspects, the risk mitigation action may require and be performed responsive to a user input manually provided by the user of the customer device 102.

As previously described, the unique authentication request 104 can include authentication information that is dynamically provided by a user of the customer device 102 upon initial receipt of an unauthenticated communication. Such authentication information can include text (e.g., a phrase, a random alphanumeric sequence, a date, a name, a PIN code, a place, etc.), audio (e.g., a song, a voice recording, etc.), a picture, and/or a video, as dynamically selected by the user of the customer device 102 in real time. Authentication information used to authenticate a first communication may not be the same as authentication information used to authenticate a second communication. It shall be appreciated that the dynamic nature of the authentication information, as provided by the user can enhance security and make it more difficult for a malicious actor to impersonate the service provider. For example, the authentication information may include a phrase and the user of the customer device 102 may require the originator of the unauthenticated communication to recite the phrase. The authentication information may include an image and the user of the customer device 102 may require the originator of the unauthenticated communication to describe the image. The authentication information may include an audio file including a statement made by the user of the customer device 102 in their own voice, and the user of the customer device 102 may require the originator of the unauthenticated communication to play the audio file for the user of the customer device 102 to confirm. According to some non-limiting aspects, the authentication response 114 may be digitally transmitted to the customer device 102 and the application accessed by the customer device 102 may autonomously assess the authentication response 114.

According to some non-limiting aspects, the communication may be initiated via the service provider server 108, which establishes its own communication channel 118 and provides its own authentication response 110. According to other non-limiting aspects, the system 100 can include a third party system 120 configured to initiate an action on behalf of the customer device 102 and/or the service provider server 108. For example, the third party system 120 can include the police, a government agency, an IT management firm, and/or a telecommunications provider, or any other party capable of assisting in the implementation of the aforementioned risk mitigation actions.

According to some non-limiting aspects, particular authentication information provided by the user of the customer device 102 can be programmed by the user of the customer device 102 to be associated with a special circumstance and a specific risk mitigation action. The authentication information, association with the special circumstance, and specific risk mitigation action can be stored prior to initiation of the communication. If the service provider server 108 and/or service provider device 112 receives a unique authentication request 104 that includes such pre-defined authentication information, the service provider may recognize that the special circumstance applies and may initiate the specific risk mitigation action. For example, the user may pre-configure the system 100 such that authentication information including the phrase “whiskey tango foxtrot” indicates that the user is in a state of duress (e.g., is being held at gunpoint, is being robbed, is injured, etc.) or is otherwise in need of special assistance from the service provider. Specific risk mitigation actions may include deploying the police or medical assistance to the location of the customer device 102, locking an account hosted by the service provider, and/or denying a transaction, amongst other actions. It shall be appreciated that the unique authentication request 104 can include location information associated with the customer device 102 and that the location of the customer device 102 can be determined based on the unique authentication request 104. Therefore, if the service provider recognizes unusual behavior from the user of the customer device 102, the service provider may initiate a communication with the user of the customer device 102 to provide the user of the customer device 102 with an opportunity to provide the pre-defined authentication information. Otherwise, the user of the customer device 102 may provide such pre-defined authentication information independent of the service provider initiating a communication.

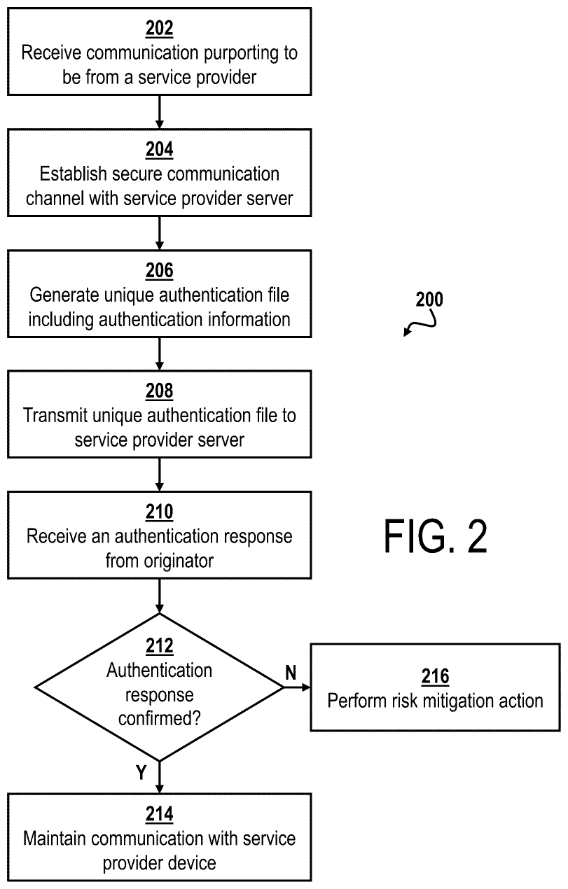

Referring now to FIG. 2, a flow diagram of a method 200 performed by the system 100 of FIG. 1 is depicted according to one non-limiting aspect of the present disclosure. It shall be appreciated that, according to some non-limiting aspects, the steps of the method 200 of FIG. 2 can be implemented by the computing device 102 (FIG. 1), a user of the computing device 102 (FIG. 1), or combinations thereof. According to the non-limiting aspect of FIG. 2, the method 200 can include receiving 202 a communication initiated by an originator that purports to be from a service provider. In response to the received communication, the method 200 can further include establishing 204 a secure communication channel 103 (FIG. 1) with a service provider server 108 (FIG. 1). For example, a user of the customer device 102 (FIG. 1) can access the application, which can be configured for use throughout the ordinary course of dealing between the customer and the service provider with access restricted and only granted via the approval of user authenticating credentials.

The method 200 of FIG. 2 can further include generating 206 a unique authentication request 104 (FIG. 1) based on authentication information provided to the customer device 102 (FIG. 1) via a user input and transmitting 208 the unique authentication request 104 (FIG. 1) to the service provider server 108 (FIG. 1) via the secure communication channel 103 (FIG. 1), which can be accessed by the service provider device 112 (FIG. 1) or a user thereof. Assuming the originator of the communication is in fact the service provider or a registered agent of the service provider, the originator should be able to easily access the unique authentication information and its associated authentication information and transmit an authentication response 114 (FIG. 1) to the customer device 102 (FIG. 1). Thus, the method 200 can further include receiving 210 the authentication response 114 (FIG. 1).

Upon receipt of the authentication response 114 (FIG. 1), the method 200 of FIG. 2 can include confirming 212 authentication information contained within or otherwise associated with the authentication response 114 (FIG. 1). For example, the authentication information may include a phrase and the user of the customer device 102 (FIG. 1) may require the originator of the unauthenticated communication to recite the phrase. The authentication information may include an image and the user of the customer device 102 (FIG. 1) may require the originator of the unauthenticated communication to describe the image. The authentication information may include an audio file including a statement made by the user of the customer device 102 (FIG. 1) in their own voice, and the user of the customer device 102 (FIG. 1) may require the originator of the unauthenticated communication to play the audio file for the user of the customer device 102 (FIG. 1) to confirm. According to some non-limiting aspects, the authentication response 114 (FIG. 1) may be digitally transmitted to the customer device 102 (FIG. 1) and the customer device 102 (FIG. 1) may autonomously assess the authentication response 114 (FIG. 1) to confirm the authentication information.

Assuming the authentication information is confirmed, the method 200 of FIG. 2 can include maintaining 214 the communication, as the user of the customer device 102 (FIG. 1) will have established confidence that the originator of the communication is the service provider or an authorized agent of the service provider. However, if the authentication information is not confirmed, the method 200 can further include performing 216 a risk mitigation action, such as terminating the unverified communication channel 116, recording the communication, recording information associated with the communication (e.g., a name of originator, a date, a time, a location, a phone number, an IP address, etc.), reporting the communication to the service provider or a third party (e.g., the police, an IT management firm, a telecommunications provider, etc.), and/or blocking information associated with the communication (e.g., a phone number, an IP address, etc.), thereby preventing the originator from initiating future communications with the customer device 102 (FIG. 1), amongst other risk mitigation actions. Such risk mitigation actions can be manually implemented by the user of the customer device 102 (FIG. 1) or autonomously implemented via the application accessed by the customer device 102 (FIG. 1).

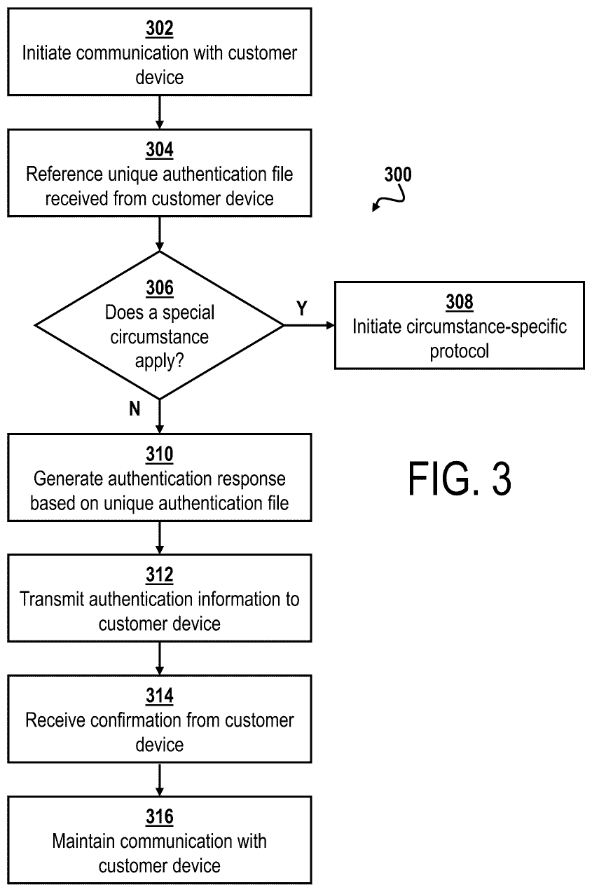

Referring now to FIG. 3, a flow chart of another method 300 performed by the system 100 of FIG. 1 is depicted according to one non-limiting aspect of the present disclosure. It shall be appreciated that, according to some non-limiting aspects, the steps of the method 300 of FIG. 3 can be implemented by the service provider device 112 (FIG. 1) a user of the service provider device 112 (FIG. 1), or combinations thereof. According to the non-limiting aspect of FIG. 3, the method 300 can include initiating 302 a communication with a customer device 102 (FIG. 1) and referencing 304 a unique authentication request 104 (FIG. 1) received from the customer device 102 (FIG. 1) in response to an authentication request issued via the customer device 102 (FIG. 1). The method 300 can further include assessing 306 whether or not a special circumstance applies based on authentication information within or otherwise associated with the authentication request 104 (FIG. 1).

Assuming that a special circumstance does not apply, as determined based on the authentication information, the method 300 of FIG. 3 can further include generating 310 an authentication response 114 (FIG. 1) that includes the authentication information and transmitting 312 the authentication response 114 (FIG. 1) to the customer device 102 (FIG. 1). The method 300 can further include receiving 314 a confirmation that the authentication information provided via the authentication response 114 (FIG. 1) has been confirmed via the customer device 102 (FIG. 1) and maintaining 316 the communication with the customer device 103 (FIG. 1). If, however, it is determined that a special circumstance does apply, the method 300 can further include initiating 308 a circumstance-specific protocol, including performance of a specific risk mitigation action. For example, the user may pre-configure the system 100 (FIG. 1) such that authentication information including the phrase “whiskey tango foxtrot” indicates that the user is in a state of duress (e.g., is being held at gunpoint, is being robbed, is injured, etc.) or is otherwise in need of special assistance from the service provider. Specific risk mitigation actions may include deploying the police or medical assistance to the location of the customer device 102 (FIG. 1), locking an account hosted by the service provider, and/or denying a transaction, amongst other actions.

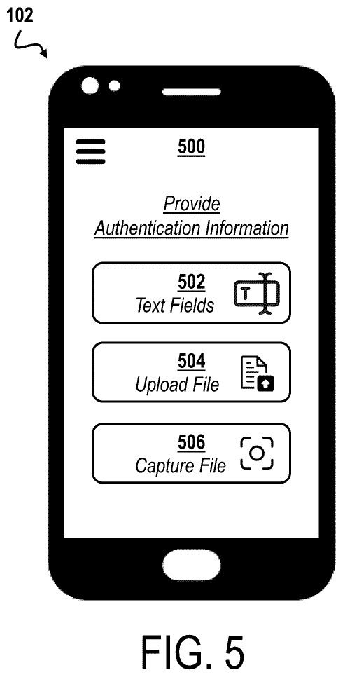

Referring now to FIG. 4, a first user interface 400 to be displayed via the customer device 102 of the system 100 of FIG. 1 is depicted according to a non-limiting aspect of the present disclosure. According to the non-limiting aspect of FIG. 4, the user interface 400 can be deployed in response to an application accessed by the customer device 104 (FIG. 1) and can include various information used by the customer throughout the ordinary course of dealing with the service provider, including an account balance and/or a list of recent transactions. Notably, the user interface 400 can further include a first widget 402 configured to initiate a communication authentication protocol in response to a user interaction. For example, interacting with the first widget 402 can cause the customer device 102 (FIG. 1) to present a second user interface 500, as depicted in FIG. 5.

According to the non-limiting aspect of FIG. 5, the second user interface 500 can include one or more means by which a user of the customer device 102 (FIG. 1) can provide authentication information. For example, the second user interface 500 can include a second widget 502, a third widget 504, and/or a third widget 506. The second widget 502 can include a form field configured to receive a text-based authentication information based on a user input from a user of the customer device 102 (FIG. 1). The third widget 504 can include an “upload” functionality configured to enable the user to browse a local and/or remote storage via the customer device 102 (FIG. 1) for text-based, image-based, video-based, or audio-based authentication information that was previously captured. The fourth widget 506 can include a “capture” functionality configured to enable the user to generate new image-based, video-based, or audio-based authentication information in real time. The fifth widget 506 can include a “capture” functionality configured to enable the user to capture or generate new image-based, video-based, or audio-based authentication information in real time, for example, via one or more sensors communicatively coupled to the customer device 102 (FIG. 1). In other words, a user can use the second widget 502, third widget 504, and/or fourth widget 506 to dynamically provide the customer device 102 (FIG. 1) with authentication information in real time. It shall be appreciated that, according to some non-limiting aspects, the second user interface 500, including the second widget 502, the third widget 504, and/or the fourth widget 506, can be used or modified to pre-define authentication information to be associated with a special circumstance and/or specific risk mitigation action.

Referring now to FIG. 6, a third user interface 600 to be displayed via the customer device 102 of the system 100 of FIG. 1 is depicted according to a non-limiting aspect of the present disclosure. According to the non-limiting aspect of FIG. 6, the third user interface 600 can include a fifth widget 602 configured to confirm authentication information received via the authentication response 114 (FIG. 1) and a seventh widget 606 configured to reject authentication information received via the authentication response 114 (FIG. 1). For example, upon receiving the authentication response 114 (FIG. 1) from the service provider device 112 (FIG. 1), the third user interface 600 can enable a user of the customer device 102 (FIG. 1) to perform the confirmation process described in reference to the method 200 of FIG. 2.

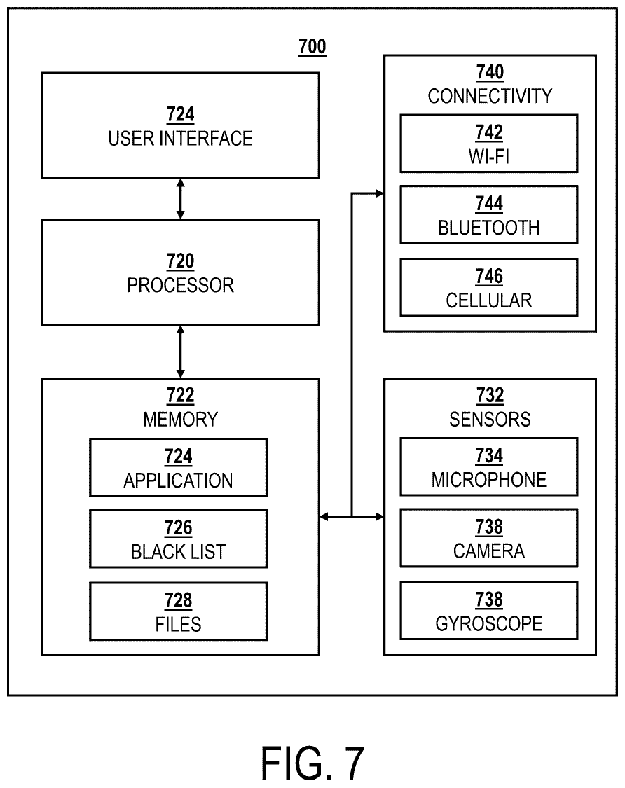

Referring now to FIG. 7, a block diagram of a mobile communication device 700 according to various non-limiting aspects of the present disclosure. The mobile communication device 700, for example, can be configured for use with the system 100 of FIG. 1 or to implement the method 200 of FIG. 2. According to some aspects, the mobile communication device 700 is representative of the service provider device 112 of the system 100 of FIG. 1 and can be configured to perform the method 300 of FIG. 3.

According to the non-limiting aspect of FIG. 7, the mobile communication device can include a user interface 724, a processor 720, a memory 722, a communication circuit 740, and/or one or more sensors 732. For example, the user interface can be a display configured to depict the user interfaces 400, 500, 600 of FIGS. 4-6. The user interface 724 can be configured to receive textual user inputs from a user. Alternately or additionally, the user interface 724 can include a speaker configured to interface with the user by playing audio files. The user interface can be integral or peripheral relative to the mobile communication device 700. The memory 722 can be configured to store one or more applications 724, including the applications described herein. The memory 722 can be further configured to store a black list 726. As previously described, the mobile communication device 700 can block the unverified originator from initiating another communication by storing the information associated with the communication on a black list stored in the memory 722 of the mobile communication device 700. The processor 720 of the mobile communication device can be configured to autonomously reject communications comprising information on the black list 726 when they are received via the connectivity circuit 740. The memory 722 can be further configured to store one or more files 728, including files 728 generated based on inputs provided via the user interface 724 and/or one or more sensors 732. The one or more sensors 732 can include a microphone 734 configured to receive audible inputs, a camera 738 configured to capture visual inputs, and/or a accelerometer or gyroscope 738 configured to generate data associated with a position or orientation of the mobile communication device 700. Any of the aforementioned inputs can be used to generate the unique authentication request 104 (FIG. 1). The mobile communication device 700 can further include a communication circuit 740 configured for wireless or wired communications. According to the non-limiting aspect of FIG. 7, the communication circuit 740 can include Wi-Fi connectivity circuitry 742, Bluetooth connectivity circuitry 744, and/or cellular connectivity circuitry 746.

In one general aspect, therefore, the present invention is directed to a method including the steps of receiving, via a mobile communication device, a communication from an unverified originator via a first communication channel, in response to receiving the communication, establishing, via the mobile communication device, a second, secure communication channel between the mobile communication device and a service provider server, wherein the second, secure communication channel is provided via an application stored in a memory of the mobile communication device and executed by a processor of the mobile communication device, receiving, via the mobile communication device, a first user input from a user of the mobile communication device, wherein the first user input includes authentication information in response to the communication, generating, via the mobile communication device, a unique authentication request including the authentication information, transmitting, via the mobile communication device, the unique authentication request to the service provider server via the second, secure communication channel, receiving and outputting to the user of the mobile communication device, via the mobile communication device, an authentication response from the originator of the communication via the first communication channel, and determining, via the mobile communication device, whether the originator of the communication is a service provider associated with the user of the mobile communication device based on the authentication response.

In various implementations, determining whether the unverified originator of the communication is a service provider associated with the user of the mobile communication device based on the authentication response includes determining, via the mobile communication device, that the unverified originator of the communication is the service provider, and the method further includes, in response to determining that the unverified originator of the communication is the service provider, maintaining, via the mobile communication device, the communication by preserving the unverified communication channel.

In other implementations, determining whether the unverified originator of the communication is a service provider associated with the user of the mobile communication device based on the authentication response includes determining, via the mobile communication device, that the originator of the communication is not the service provider, and the method further includes, in response to determining that the unverified originator of the communication is not the service provider, performing, via the mobile communication device, a risk mitigation action.

In various implementations, the risk mitigation action includes terminating, via the mobile communication device, the communication by terminating the first communication channel.

In various implementations, the risk mitigation action includes recording, via the mobile communication device, the communication in the memory of the mobile communication device.

In various implementations, the risk mitigation action includes recording, via the mobile communication device, information associated with the communication in a memory of the mobile communication device, wherein the information associated with the communication includes at least one of a name of originator, a date, a time, a location, a phone number, and an IP address, or combinations thereof.

In various implementations, the risk mitigation action further includes reporting, via the mobile communication device, by causing the mobile computing device to transmit the information associated with the communication to a third party system via a communication circuit of the mobile computing device.

In various implementations, the third party system is associated with at least one of the service provider, a police unit, a government agency, an information technology management firm, and a telecommunications provider, or combinations thereof.

In various implementations, the risk mitigation action further includes preventing, via the mobile communication device, the unverified originator from initiating another communication by storing the information associated with the communication on a black list stored in the memory of the mobile communication device, wherein the mobile communication device is configured to autonomously reject communications including information on the black list.

In various implementations, outputting the authentication response includes playing the authentication response via a speaker of the mobile communication device.

In various implementations, outputting the authentication response includes presenting the authentication response via a display of the mobile communication device.

In various implementations, the authentication response includes responsive authentication information, and wherein determining whether the originator of the communication is actually the service provider includes determining, via the mobile communication device, whether the responsive authentication information in the authentication response corresponds to the authentication information in the unique authentication request.

In various implementations, determining whether the originator of the communication is actually the service provider includes autonomously determining, via the mobile communication device, whether the originator of the communication is actually the service provider.

In one general aspect, therefore, the present invention is directed to a method including the steps of initiating, via a service provider device, a communication with a mobile communication device via a first communication channel, receiving, via a service provider server, a unique authentication request provided by the mobile communication from the mobile communication device via a secure, second channel, wherein the unique authentication request includes authentication information provided via a user input received by an application stored in a memory of the mobile communication device and executed by a processor of the mobile communication device, in response to the communication having been initiated by the service provider device, referencing, via the service provider device, the unique authentication request stored on the service provider server, transmitting, via the service provider device, an authentication response to the mobile communication device including responsive authentication information based on the authentication information, receiving, via the service provider device, a confirmation that the authentication information in unique authentication request corresponds to the responsive authentication information in the authentication response, and maintaining, via the service provider device, the communication via the first communication channel based on the confirmation.

In various implementations, the method further includes, prior to the communication having been initiated by the service provider device, receiving and storing, via the service provider server, pre-defined authentication information from the mobile communication device via the secure, second channel, wherein the pre-defined authentication information communicates to a user of the service provider device that a user of the mobile communication device is in a special circumstance, determining, via the service provider device, that the authentication information in the unique authentication request corresponds to the pre-defined authentication information stored on the service provider server, and determining, via the service provider device, that the user of the mobile communication device is in the special circumstance based on the correspondence between the authentication information in the unique authentication request and the pre-defined authentication information stored on the service provider server.

In various implementations, the method further includes performing, via the service provider device, a pre-defined risk mitigation action based on the determination that the special circumstance applies to the communication.

In various implementations, performing the pre-defined risk mitigation action includes determining, via the service provider device, a location of the mobile communication device based on geolocation data associated with the unique authentication request and/or the communication.

In various implementations, the pre-defined risk mitigation action includes deploying a police officer or medical assistance to the determined location of the mobile communication device.

In various implementations, the pre-defined risk mitigation action includes locking an account of the user of the mobile communication device hosted by the service provider or denying a transaction request initiated by the mobile communication device.

In various implementations, the method further includes detecting, via the service provider server, unusual behavior associated with the mobile communication device, wherein the communication is initiated based on the detection of unusual behavior associated with the mobile communication device.

In another general aspect, therefore, the present invention is directed to a system including a service provider server, and a mobile communication device including a processor and a memory configured to store an application that, when executed by the processor, causes the mobile communication device to receive a communication from an unverified originator via a first communication channel, in response to receiving the communication, establish a second, secure communication channel with the service provider server, receive a first user input from a user of the mobile communication device, wherein the first user input includes authentication information in response to the communication, generate a unique authentication request including the authentication information, transmit the unique authentication request to the service provider server via the second, secure communication channel, receive an authentication response from the originator of the communication via the first communication channel, and determine whether the originator of the communication is a service provider associated with the user of the mobile communication device based on the authentication response.

In various implementations, when executed by the processor, the application further causes the mobile communication device to determine that the unverified originator of the communication is not the service provider, and perform a risk mitigation action based on the determination that the unverified originator of the communication is not the service provider.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various aspects have been described herein, it should be apparent that various modifications, alterations, and adaptations to those aspects may occur to persons skilled in the art with attainment of at least some of the advantages. The disclosed aspects are therefore intended to include all such modifications, alterations, and adaptations without departing from the scope of the aspects as set forth herein.

What is claimed is:

1. A method comprising:
receiving, via a mobile communication device, a communication from an unverified originator via a first communication channel;
in response to receiving the communication, establishing, via the mobile communication device, a second, secure communication channel between the mobile communication device and a service provider server, wherein the second, secure communication channel is provided via an application stored in a memory of the mobile communication device and executed by a processor of the mobile communication device;
receiving, via the mobile communication device, a first user input from a user of the mobile communication device, wherein the first user input comprises authentication information in response to the communication;
generating, via the mobile communication device, a unique authentication request comprising the authentication information;
transmitting, via the mobile communication device, the unique authentication request to the service provider server via the second, secure communication channel;
receiving and outputting to the user of the mobile communication device, via the mobile communication device, an authentication response from the originator of the communication via the first communication channel; and
determining, via the mobile communication device, whether the originator of the communication is a service provider associated with the user of the mobile communication device based on the authentication response.

2. The method of claim 1, wherein:
determining whether the unverified originator of the communication is a service provider associated with the user of the mobile communication device based on the authentication response comprises determining, via the mobile communication device, that the unverified originator of the communication is the service provider; and
the method further comprises, in response to determining that the unverified originator of the communication is the service provider, maintaining, via the mobile communication device, the communication by preserving the unverified communication channel.

3. The method of claim 1, wherein:
determining whether the unverified originator of the communication is a service provider associated with the user of the mobile communication device based on the authentication response comprises determining, via the mobile communication device, that the originator of the communication is not the service provider; and
the method further comprises, in response to determining that the unverified originator of the communication is not the service provider, performing, via the mobile communication device, a risk mitigation action.

4. The method of claim 3, wherein the risk mitigation action comprises terminating, via the mobile communication device, the communication by terminating the first communication channel.

5. The method of claim 3, wherein the risk mitigation action comprises recording, via the mobile communication device, the communication in the memory of the mobile communication device.

6. The method of claim 3, wherein the risk mitigation action comprises recording, via the mobile communication device, information associated with the communication in a memory of the mobile communication device, wherein the information associated with the communication comprises at least one of a name of originator, a date, a time, a location, a phone number, and an IP address, or combinations thereof.

7. The method of claim 6, wherein the risk mitigation action further comprises reporting, via the mobile communication device, by causing the mobile computing device to transmit the information associated with the communication to a third party system via a communication circuit of the mobile computing device.

8. The method of claim 7, wherein the third party system is associated with at least one of the service provider, a police unit, a government agency, an information technology management firm, and a telecommunications provider, or combinations thereof.

9. The method of claim 6, wherein the risk mitigation action further comprises preventing, via the mobile communication device, the unverified originator from initiating another communication by storing the information associated with the communication on a black list stored in the memory of the mobile communication device, wherein the mobile communication device is configured to autonomously reject communications comprising information on the black list.

10. The method of claim 1, wherein outputting the authentication response comprises playing the authentication response via a speaker of the mobile communication device.

11. The method of claim 1, wherein outputting the authentication response comprises presenting the authentication response via a display of the mobile communication device.

12. The method of claim 1, wherein the authentication response comprises responsive authentication information, and wherein determining whether the originator of the communication is actually the service provider comprises determining, via the mobile communication device, whether the responsive authentication information in the authentication response corresponds to the authentication information in the unique authentication request.

13. The method of claim 1, wherein determining whether the originator of the communication is actually the service provider comprises autonomously determining, via the mobile communication device, whether the originator of the communication is actually the service provider.

14. A method comprising:
initiating, via a service provider device, a communication with a mobile communication device via a first communication channel;
receiving, via a service provider server, a unique authentication request provided by the mobile communication from the mobile communication device via a secure, second channel, wherein the unique authentication request comprises authentication information provided via a user input received by an application stored in a memory of the mobile communication device and executed by a processor of the mobile communication device;
in response to the communication having been initiated by the service provider device, referencing, via the service provider device, the unique authentication request stored on the service provider server;
transmitting, via the service provider device, an authentication response to the mobile communication device comprising responsive authentication information based on the authentication information;
receiving, via the service provider device, a confirmation that the authentication information in unique authentication request corresponds to the responsive authentication information in the authentication response; and
maintaining, via the service provider device, the communication via the first communication channel based on the confirmation.

15. The method of claim 12, further comprising:
prior to the communication having been initiated by the service provider device, receiving and storing, via the service provider server, pre-defined authentication information from the mobile communication device via the secure, second channel, wherein the pre-defined authentication information communicates to a user of the service provider device that a user of the mobile communication device is in a special circumstance;
determining, via the service provider device, that the authentication information in the unique authentication request corresponds to the pre-defined authentication information stored on the service provider server; and
determining, via the service provider device, that the user of the mobile communication device is in the special circumstance based on the correspondence between the authentication information in the unique authentication request and the pre-defined authentication information stored on the service provider server.

16. The method of claim 13, further comprising:
performing, via the service provider device, a pre-defined risk mitigation action based on the determination that the special circumstance applies to the communication.

17. The method of claim 14, wherein:
performing the pre-defined risk mitigation action comprises determining, via the service provider device, a location of the mobile communication device based on geolocation data associated with the unique authentication request and/or the communication.

18. The method of claim 15, wherein: the pre-defined risk mitigation action comprises deploying a police officer or medical assistance to the determined location of the mobile communication device.

19. The method of claim 14, wherein the pre-defined risk mitigation action comprises locking an account of the user of the mobile communication device hosted by the service provider or denying a transaction request initiated by the mobile communication device.

20. The method of claim 14, further comprising:
detecting, via the service provider server, unusual behavior associated with the mobile communication device, wherein the communication is initiated based on the detection of unusual behavior associated with the mobile communication device.

21. A system comprising:
a service provider server; and
a mobile communication device comprising a processor and a memory configured to store an application that, when executed by the processor, causes the mobile communication device to:
receive a communication from an unverified originator via a first communication channel;
in response to receiving the communication, establish a second, secure communication channel with the service provider server;
receive a first user input from a user of the mobile communication device, wherein the first user input comprises authentication information in response to the communication;
generate a unique authentication request comprising the authentication information;
transmit the unique authentication request to the service provider server via the second, secure communication channel;
receive an authentication response from the originator of the communication via the first communication channel; and
determine whether the originator of the communication is a service provider associated with the user of the mobile communication device based on the authentication response.

22. The system of claim 19, wherein, when executed by the processor, the application further causes the mobile communication device to:
determine that the unverified originator of the communication is not the service provider; and
perform a risk mitigation action based on the determination that the unverified originator of the communication is not the service provider.
